(19) United States
(12) Patent Application Publication
(10) Pub. No.: US 2012/0205907 A1
(43) Pub. Date: Aug. 16, 2012

(54) HYDRAULIC LINE ATTACHMENT DEVICE AND METHOD

(75) Inventors: Neal W. Westendorf, Dakota Dunes, SD (US); Matthew N. Westendorf, Onawa, IA (US)

(73) Assignee: Westendorf Manufacturing Co., Inc., Onawa, IA (US)

(21) Appl. No.: 13/398,075

(22) Filed: Feb. 16, 2012

Related U.S. Application Data
(60) Provisional application No. 61/443,531, filed on Feb. 16, 2011.

(51) Int. Cl. F16L 39/00; B21D 53/88; B23P 19/00

(52) U.S. Cl. 285/120.1; 29/469; 29/897.2

(57) ABSTRACT

A hydraulic line attachment device is provided. The hydraulic line attachment device includes a first assembly and a second assembly. The first assembly includes a first frame, a plurality of first hydraulic line couplers held to the first frame, and a first coupling member. The second assembly comprises a second frame, a plurality of second hydraulic line couplers held to the second frame, and a second coupling member constructed to engage the first coupling member and align the plurality of first hydraulic line couplers with the plurality of second hydraulic line couplers. At least one of the first coupling member and the second coupling member comprises a shaft having a spiral track, and the other of the first coupling member and the second coupling member comprises a projection arrangement constructed to engage the spiral track. The hydraulic line attachment device is constructed so that rotation of the first coupling member relative to the second coupling member provides tightening or loosening of the first assembly relative to the second assembly. A method for attaching a first set of hydraulic lines to a second set of hydraulic lines is provided.

### CROSS REFERENCE TO RELATED APPLICATION

The present application is based on the disclosure of U.S. Application Ser. No. 61/443,531 that was filed with the United States Patent and Trademark Office on Feb. 16, 2011. Right of priority to the filing of U.S. Application Ser. No. 61/443,531 is claimed, to the extent appropriate. The entire disclosure of U.S. Application Ser. No. 61/443,531 is incorporated herein by reference.

### FIELD OF THE INVENTION

The invention relates to a hydraulic line attachment device and to a method for attaching a plurality of hydraulic line couplers together. Hydraulic line couplers are male and female coupling members that, when not attached are closed to the flow hydraulic fluid therethrough, and when attached are opened to the flow of hydraulic fluid therethrough. In order to attach a male and female hydraulic line coupling members together, it is necessary to overcome the force that normally keeps them closed to the flow of hydraulic fluid when they are not attached. As a result of being closed to the flow of hydraulic fluid when they are not attached, hydraulic fluid does not escape through the hydraulic lines. The hydraulic line attachment device and the method for attaching a plurality of hydraulic line coupling members together can be used in applications where hydraulic lines are typically coupled and uncoupled. Examples include tractors and equipment used on tractors such as front end loaders.

### BACKGROUND OF THE INVENTION

Hydraulic lines for powering hydraulic cylinders can be found in a number of environments. Frequently, where hydraulic cylinders are found, hydraulic lines are clustered for quick and easy attachment and detachment. One example of an environment where clusters of hydraulic lines to power hydraulic cylinders are frequently found is on tractors. Typically a front end loader can attach to a tractor. A front end loader often has a pair of boom assemblies that have rearward ends that pivotally attach to a tractor, and forward ends that pivotally attach to buckets, clam shells, plow, fork lifts, bale spears, etc. Hydraulic cylinders are provided for operating the front-end loaders and the attachments. Some exemplary front end loaders using hydraulic lines to power hydraulic cylinders are described by U.S. Pat. No. 3,512,665 to Westendorf; U.S. Pat. No. 4,085,856 to Westendorf; U.S. Pat. No. 4,787,811 to Langenfeld et al.; U.S. Pat. No. 4,051,962 to Westendorf; U.S. Pat. No. 4,606,692 to Langenfeld et al.; and U.S. Pat. No. 4,930,974 to Langenfeld et al.

Several hydraulic line attachment devices are described in the prior art. For example, see U.S. Pat. No. 5,507,530 to Mahaney, U.S. Pat. No. 5,316,347 to Arosio, U.S. Pat. No. 5,984,371 to Mailleux, U.S. Pat. No. 7,021,668 to Langenfeld et al., and U.S. Pat. No. 7,717,471 to Langenfeld et al. In general, these hydraulic line attachment devices are used to connect and disconnect a plurality of hydraulic line couplers. Hydraulic line couplers are well known in the art and include a male coupler and a female coupler. When the male and female couplers are not engaged, they are closed to the flow of hydraulic fluid therethrough. When the male and female hydraulic line couplers are connected together, they are open to the flow of hydraulic fluid therethrough. Because it is convenient and desirable to not drain hydraulic fluid from the hydraulic lines when connecting and disconnecting various hydraulically driven devices, hydraulic line couplers are desirable. In order to prevent leakage of hydraulic fluid when the male and female couplers are not engaged, the male and female couplers utilize a spring that closes the coupler to the flow of hydraulic fluid. In order to engage the male and female hydraulic couplers, the springs within the couplers can be compressed in order to establish an open connection. Sometimes, the force required for engaging a male and female hydraulic line coupler can be substantial. In the situation where a plurality of hydraulic line couplers are connected via a hydraulic line attachment device, it is desirable to control both the attachment and the detachment of the hydraulic line couplers for safety reasons.

### SUMMARY OF THE INVENTION

A hydraulic line attachment device is provided according to the invention. The hydraulic line attachment device includes a first assembly and a second assembly. The first assembly includes a first frame, a plurality of first hydraulic line couplers held to the first frame, and a first coupling member. The second assembly comprises a second frame, a plurality of second hydraulic line couplers held to the second frame, and a second coupling member constructed to engage the first coupling member and align the plurality of first hydraulic line couplers with the plurality of second hydraulic line couplers. At least one of the first coupling member and the second coupling member comprises a shaft having a spiral track, and the other of the first coupling member and the second coupling member comprises a projection arrangement constructed to engage the spiral track. The hydraulic line attachment device is constructed so that rotation of the first coupling member relative to the second coupling member provides tightening or loosening of the first assembly relative to the second assembly.

A method for attaching a first set of hydraulic lines to a second set of hydraulic lines is provided according to the invention. The method includes a step of connecting a plurality of first hydraulic line couplers to a plurality of second hydraulic line couplers by connecting a first assembly and a second assembly. The first assembly comprises a first frame, a plurality of first frame hydraulic line couplers held to the first frame, and a first coupling member. The second assembly comprises a second frame, a plurality of second hydraulic line couplers held to the second frame, and a second coupling member constructed to engage the first coupling member and align the plurality of first hydraulic line couplers with the plurality of second hydraulic line couplers. At least one of the first coupling member and the second coupling member comprises a shaft having a spiral track, and the other of the first coupling member and the second coupling member comprises a projection arrangement constructed to engage the spiral track. The method additionally includes a step of rotating the first coupling member or the second coupling member to provide tightening or loosening of the first assembly relative to the second assembly. The method can additionally include a step of detaching by reversing the rotation. A handle can be provided to assist with the rotation.

### BRIEF DESCRIPTION OF THE DRAWINGS

FIG. 1 is a side view of a hydraulic line attachment device according to the principles of the invention and coupled to a tractor including a front-end loader.

FIG. 2 is an exploded, perspective view of a hydraulic line attachment device according to the principles of the invention.

FIG. 3 is an exploded, perspective view of the hydraulic line attachment device of FIG. 2.

### DETAILED DESCRIPTION

This invention relates to hydraulic line attachment devices for connecting clusters of hydraulic lines. The hydraulic line attachment device can utilize a cam type arrangement to tighten two sets or clusters of hydraulic lines together. The hydraulic line attachment device can include two assemblies comprising intermating hydraulic line couplers, and the assemblies can be constructed to be tightened to each other. A first assembly can comprise a first frame constructed for holding a plurality of first hydraulic line couplers and a first coupling member. A second assembly can comprise a second frame constructed for holding a plurality of second hydraulic line couplers and a second coupling member. The first coupling member and the second coupling member are constructed to engage each other and align the plurality of first hydraulic line couplers with the plurality of second line couplers. In the hydraulic line attachment device, at least one of the coupling members comprises a shaft constructed to engage the other coupling member. The other coupling member comprises a projection member that engages the shaft to provide movement of the first assembly relative to the second assembly. The first and second coupling members interact to pull together the first assembly and the second assembly, and can interact to provide separation of the first assembly relative to the second assembly. Because the hydraulic line couplers can be fairly difficult to connect together, it is desirable for the hydraulic line attachment device to provide controlled movement of the first assembly relative to the second assembly when both connecting and disconnecting the plurality of first and second hydraulic line couplers.

The invention will now be described by reference to the several drawing figures. The functional features of the invention can be embodied in any of a number of specific configurations. It will be appreciated, however, that the illustrated embodiments are provided for descriptive purposes and should not be used to limit the invention.

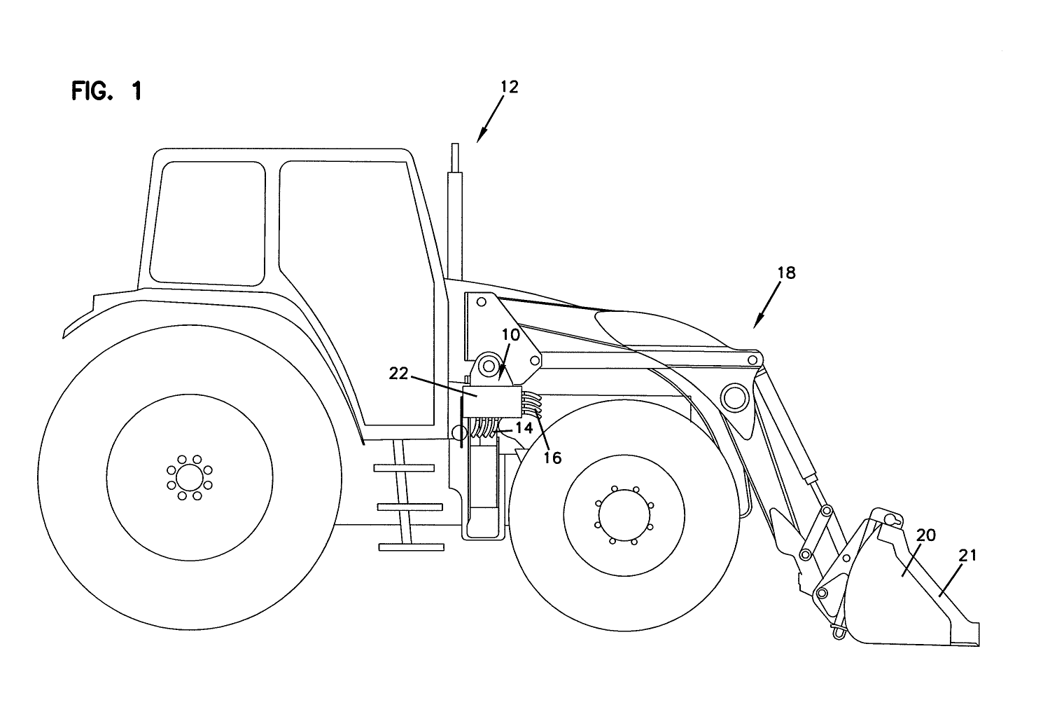

FIG. 1 illustrates a hydraulic line attachment device 10 attached to a tractor 12. The hydraulic line attachment device 10 includes a plurality of hydraulic lines 14 extending from the tractor, and a plurality of hydraulic lines 16 extending from the front end loader 18. The hydraulic line attachment device 10 provides for attaching and detaching the plurality of hydraulic lines 14 and 16. By attaching the plurality of hydraulic lines 14 and 16, it is possible to hydraulically operate the front end loader 18 and the attachment 20 on the front end loader by the hydraulic drive system on the tractor 12. The attachment 20 on the front end loader 18 is shown as a bucket 21.

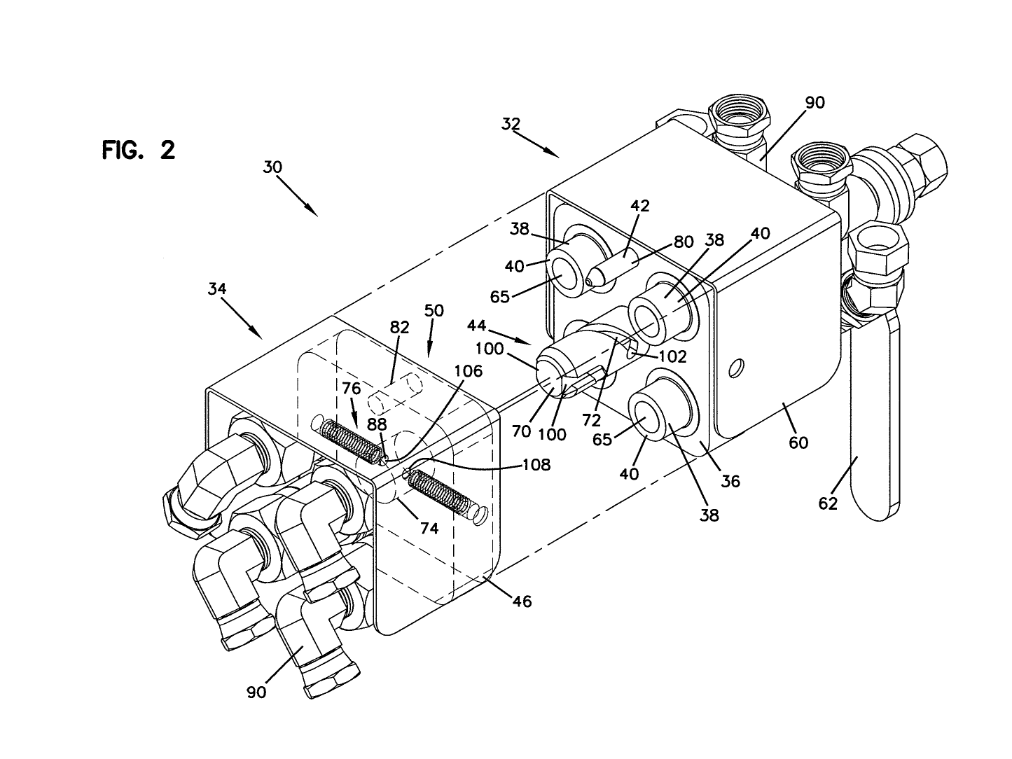

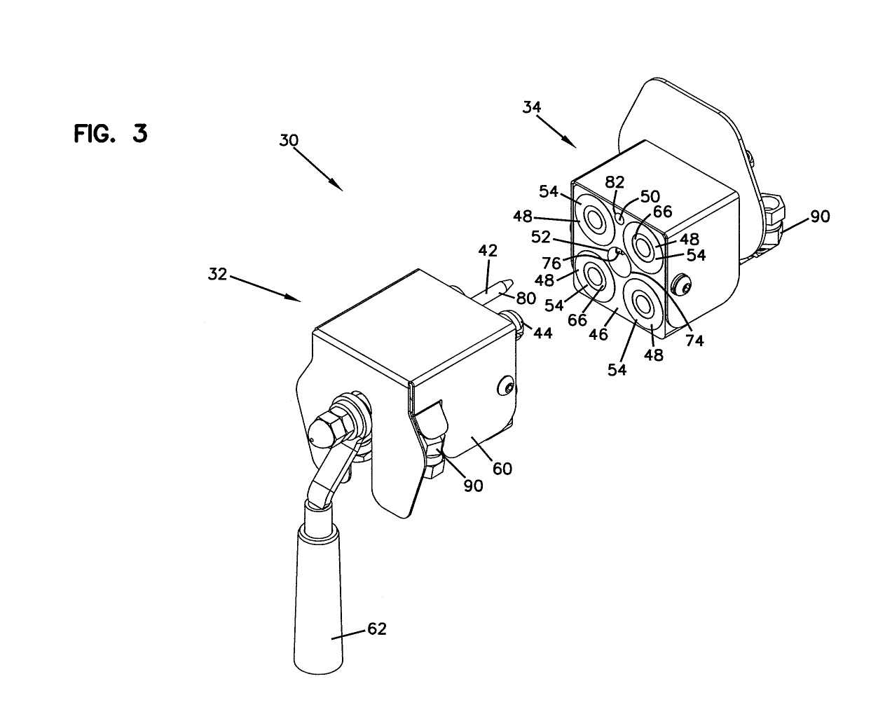

A hydraulic line attachment device 30 is illustrated in more detail in FIGS. 2 and 3. The hydraulic line attachment device 30 may be the hydraulic line attachment device 10. It should be appreciated that the hydraulic line attachment device 10 can include a covering sheath 22 that covers and conceals the moving parts.

Now referring to FIGS. 2 and 3, the hydraulic line attachment device 30 includes a first assembly 32 and a second assembly 34. The first assembly 32 includes a first plate 36 for holding a plurality of hydraulic line couplers 38. For the hydraulic line attachment device 30, four hydraulic line couplers are shown although one will appreciate that more or less can be provided. The plurality of hydraulic line couplers 38 are male hydraulic line couplers 40. It should be understood that the first assembly 32 can include female hydraulic line couplers in place of the male hydraulic line couplers 40, if desired. The plurality of hydraulic line couplers 38 are fixed to the first plate 36. The first assembly additionally includes a guide member 42 that provides that the first assembly 32 correctly engages the second assembly 34. The first assembly 32 additionally includes a first coupling member 44.

The second assembly 34 includes a second plate 46, a plurality of hydraulic line couplers 48 attached to the second plate 46, a second guide member 50, and a second coupling member 52. The plurality of hydraulic line couplers 48 are shown as female hydraulic line couplers 54. It should be understood that the second assembly 34 can include male hydraulic line couplers in place of female hydraulic line couplers 54, if desired. The plurality of hydraulic line couplers 48 are fixed to the second plate 46. The second guide member 50 is constructed for engaging the first guide member 42.

The first assembly 32 includes a bracket 60 for attaching the first assembly 32 in a fixed location. For example, the bracket 60 can be used for attaching the first assembly 32 to a tractor or other apparatus that includes a hydraulic drive system for powering hydraulics. A handle 62 is shown extending from the first assembly 32. The handle 62 can be used for causing the first coupling member 44 to interact with the second coupling member 52. For example, the handle 62 can cause the first coupling member 44 to rotate. Because of the bracket 60, the first assembly 32 can be considered stationary. It should be appreciated that, if desired, the bracket 60 can be placed on the second assembly 34 and the second assembly 34 can be considered stationary. In that situation, it would be desirable for the handle 62 to be provided extending from the second assembly 34. If the handle 62 is placed on the second assembly 34, it should be understood that the handle causes the second coupling member 52 to rotate.

The plurality of hydraulic line couplers 38 and 52 are well known in the industry. In general, hydraulic line couplers are male and female couplers that, when not engaged, are closed to the flow of hydraulic fluid therethrough. When male and female hydraulic couplers are engaged, they are open to the flow of hydraulic fluid therethrough. In order to provide a sufficient closure to hydraulic fluid, the male and female hydraulic line couplers can each include a spring and disk that biases the coupler closed. In order to connect a male and female hydraulic coupler together, the force of the spring needs to be overcome. In addition, the weight of the hydraulic fluid in the lines may additionally provide resistance to connecting a male and female hydraulic line coupler together. It is generally understood that the pressure in a hydraulic line will be released when it is desirable to attach or detach hydraulic line couplers. Furthermore, it is generally not sufficient to partially connect male and female hydraulic line couplers together. A partial connection may result in leakage of the male and female hydraulic line coupler and/or insufficient opening of the male and female hydraulic line couplers to the flow of hydraulic fluid therethrough. Accordingly, the male and female hydraulic line couplers are typically fully connected together in order to provide a desired connection so that the male and female hydraulic line couplers are open to the flow of hydraulic fluid therethrough. The male and female hydraulic line couplers typically include seals within the couplers so that the hydraulic fluid flows between the male and female hydraulic line couplers and does not leak outside the hydraulic line couplers. By way of example, the male hydraulic line couplers 40 include disks or members 65 that are biased by a spring to a closed position as shown in FIG. 2. Similarly, the exemplary plurality of female hydraulic line couplers 54 include disks or members 66 biased by a spring to a closed position as shown in FIG. 3. When the exemplary male and female hydraulic line couplers engage, the disks or members 65 and 66 become recessed. The exemplary hydraulic line couplers shown can be SafeWay FFEC 495-4-WES 4000 PSI MAX hydraulic line couplers.

For the hydraulic line attachment device 30, the first assembly 32 is shown containing the male hydraulic line couplers 40, and the second assembly 34 is shown containing female hydraulic line couplers 54. It should be understood that this can be reversed so that the first assembly 32 includes the plurality of female hydraulic line couplers, and the second assembly 34 includes the plurality of male hydraulic line couplers.

The first assembly 32 includes a first coupling member 44, and the second assembly 34 includes a second coupling member 52. As shown in FIG. 2, the first coupling member 44 is shown as a shaft 70 containing a spiral groove 72. The second coupling member 52 of the second assembly 34 is shown as a cylinder 74 that includes a projection arrangement 76. When the first coupling member 44 and the second coupling member 52 engage each other, the first coupling member 44 is received within the second coupling member 52. In particular, the shaft 70 is received within the cylinder 74, and the projection arrangement 76 engages the spiral grove 72. The handle 62 can be rotated causing rotation of the shaft 70. As a result of the rotation of the shaft 70, the first assembly 32 is drawn toward the second assembly 34. If desired, the cylinder 74 can be rotated relative to the shaft 70 in order to provide the connection and disconnection of the first assembly 32 relative to the second assembly 34. If it is desirable to rotate the cylinder 74, one could attach a lever to the cylinder 74 in order to rotate the cylinder 74. It should be appreciated that the first coupling member 44 can be provided on the second assembly 34, and the second coupling member 52 can be provided on the first assembly 32, if desired.

The first guide member 42 is shown as a projection 80 that engages the second guide member 50 which is shown as a recess 82. The projection 80 can engage the recess 82 to ensure that the first assembly 32 and the second assembly 34 are arranged together correctly. It should be appreciated that the first guide member 42 can be provided on the second assembly 34, and the second guide member 50 can be provided on the first assembly 32, if desired.

The hydraulic line attachment device 30 includes hydraulic line connectors 90 extending from the plurality of hydraulic line couplers 38 and 48. Hydraulic lines can be provided extending from the hydraulic line connectors 90.

In operation, the first assembly 32 is stationary, and the second assembly 34 is arranged relative to the first assembly 32 so that the first coupling member 44 is received within the second coupling member 52, and the first guide member 42 is received within the second guide member 50. In order for the first coupling member 44 to be received within the second coupling member 52, the projection arrangement 76 engages the spiral groove 72. At that point, the handle 62 can be rotated in order to draw the first assembly 32 and the second assembly 34 together so that the plurality of hydraulic line couplers 38 and 48 are fully attached together so that they are open to the flow of hydraulic fluid there through. The motion of the handle is reversed in order to separate the first assembly 32 from the second assembly 34 in a controlled manner.

The spiral groove 72 includes a front opening 100 where the projection arrangement 76 engages the spiral groove 72. Furthermore, the spiral groove 72 includes a connection end point 102 where the projections 88 can be located in order to lock the first assembly 32 and the second assembly 34 together. The projections 88 include a first projection 106 and a second projection 108 that extend beyond the cylinder 74 and are constructed to engage the spiral groove 72. In general, a 180 degree movement of the handle 62 can provide sufficient attachment or detachment between the first assembly 32 and the second assembly 34. If desired, the range of motion can be increased or decreased by selecting the slope of the spiral groove 72.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A hydraulic line attachment device comprising:
(a) a first assembly comprising a first frame, a plurality of first hydraulic line couplers held to the first frame, and a first coupling member;
(b) a second assembly comprising a second frame, a plurality of second hydraulic line couplers held to the second frame, and a second coupling member constructed to engage the first coupling member and align the plurality of first hydraulic line couplers with the plurality of second hydraulic line couplers;
(c) wherein at least one of the first coupling member and the second coupling member comprises a shaft having a spiral track, and the other of the first coupling member and the second coupling member comprises a projection arrangement constructed to engage the spiral track and wherein rotation of the first coupling member relative to the second coupling member provides tightening or loosening of the first assembly relative to the second assembly; and
(d) wherein the first hydraulic line couplers and the second hydraulic line couplers are closed to the flow of hydraulic fluid therethrough when they are detached, and are open to the flow of hydraulic fluid therethrough when they are connected together.

2. A hydraulic line attachment device according to claim 1, wherein the first assembly comprises at least four hydraulic line couplers, and the second assembly comprises at least four hydraulic line couplers.

3. A hydraulic line attachment device according to claim 1, wherein at least one of the first assembly and the second assembly is attached to a motor vehicle, wherein the other of the first assembly and the second assembly is coupled to hydraulic lines attached to a front-end loader.

4. A hydraulic line attachment device according to claim 3, wherein the hydraulic lines include a first pair of lines for raising and lowering the front-end loader.

5. A hydraulic line attachment device according to claim 4, wherein the hydraulic lines include a second pair of lines for operating an attachment of the front-end loader.

6. A hydraulic line attachment device according to claim 1, wherein the plurality of first hydraulic line couplers comprise male hydraulic line couplers, and the plurality of second hydraulic line couplers comprise female hydraulic line couplers

7. A hydraulic line attachment device according to claim 1, wherein the projection arrangement comprises a pair of projections that engage a pair of spiral tracks on the shaft.

8. A hydraulic line attachment device according to claim 1, further comprising a handle coupled to one of the first coupling member and the second coupling member, whereby rotating the handle causes tightening of the first assembly relative to the second assembly or separation of the first assembly relative to the second assembly.

9. A method for attaching a first set of hydraulic lines to a second set of hydraulic lines, the method comprising:
(a) connecting a plurality of first hydraulic line couplers to a plurality of second hydraulic line couplers by connecting a first assembly and a second assembly, wherein:
(i) the first assembly comprises a first frame, a plurality of first frame hydraulic line couplers held to the first frame, and a first coupling member;
(ii) the second assembly comprises a second frame, a plurality of second hydraulic line couplers held to the second frame, and a second coupling member constructed to engage the first coupling member and align the plurality of first hydraulic line couplers with a plurality of second hydraulic line couplers; and
(iii) wherein at least one of the first coupling member and the second coupling member comprises a shaft having a spiral track, and the other of the first coupling member and the second coupling member comprises a projection arrangement constructed to engage the spiral track; and
(b) the rotating the first coupling member or the second coupling member to provide tightening of the first assembly relative to the second assembly.

10. A method according to claim 9, wherein the first assembly comprises at least four hydraulic line couplers, and the second assembly comprises at least four hydraulic line couplers.

11. A method according to claim 9, wherein at least one of the first assembly and the second assembly is attached to a motor vehicle, wherein the other of the first assembly and the second assembly is coupled to hydraulic lines attached to a front-end loader.

12. A method according to claim 11, wherein the hydraulic lines include a first pair of lines for raising and lowering the front-end loader.

13. A method according to claim 12, wherein the hydraulic lines include a second pair of lines for operating an attachment of the front-end loader.

14. A method according to claim 9, wherein the plurality of first hydraulic line couplers comprise male hydraulic line couplers, and the plurality of second hydraulic line couplers comprise female hydraulic line couplers

15. A method according to claim 9, wherein the projection arrangement comprises a pair of projections that engage a pair of spiral tracks on the shaft.

16. A method according to claim 9, further comprising a handle coupled to one of the first coupling member and the second coupling member, whereby rotating the handle causes tightening of the first assembly relative to the second assembly or separation of the first assembly relative to the second assembly.

17. A method according to claim 9, further comprising disconnecting the plurality of first hydraulic line couplers and the plurality of second hydraulic line couplers.
